(19) United States
(12) Patent Application Publication
(10) Pub. No.: US 2020/0113653 A1
(43) Pub. Date: Apr. 16, 2020

(54) Mouth Guard

(71) Applicant: Haitham Alrawi, Upland, CA (US)

(72) Inventor: Haitham Alrawi, Upland, CA (US)

(21) Appl. No.: 16/599,288

(22) Filed: Oct. 11, 2019

Related U.S. Application Data
(60) Provisional application No. 62/745,342, filed on Oct. 13, 2018.

(51) Int. Cl. A61C 7/08

(52) U.S. Cl. CPC A61C 7/08

(57) ABSTRACT

A kit for treatment of bite problems includes an upper mouth guard for upper teeth of a patient and a lower mouth guard for lower teeth of a patient. The upper mouth guard includes a molded body having a first portion configured to cover six or fewer upper teeth of the patient including at least upper central incisors of the patient and a second portion configured to contact mucosal tissue of the patient located behind the incisors. The lower mouth guard includes a molded body having a first portion configured to cover six or fewer lower teeth of the patient including at least lower central incisors of the patient and a second portion configured to contact mucosal tissue of the patient's mouth located behind the incisors.

### CROSS-REFERENCE TO RELATED APPLICATION

This application claims the benefit of U.S. Provisional Patent Application No. 62/745,342 filed Oct. 13, 2018, the disclosure of which is hereby incorporated by reference in its entirety.

### BACKGROUND OF THE INVENTION

### Technical Field

The present invention relates generally to dental appliances and, in particular, to appliances, such as mouth guards, for correcting bite problems.

### Description of Related Art

Many persons have the tendency of grinding their teeth while sleeping. Such grinding of the teeth is involuntary and disadvantageously results in undesirable wear of the teeth, temporomandibular joint (TMJ) pain, and other jaw-related problems. In order to minimize damage caused by grinding of the teeth, numerous mouth guards configured to be positioned within the mouth between the teeth on the upper and lower jaws have been created. Such conventional mouth guards separate the upper and lower jaws from each other during sleep and, thus, prevent the teeth from grinding against each other involuntarily during sleep.

Conventional mouth guards, however, have not proven entirely satisfactory in operation. Although such mouth guards effectively eliminate teeth grinding by separating the upper and lower teeth during sleep, they do not reduce or eliminate involuntary occlusion of the teeth during sleep. Consequently, while conventional mouth guards effectively prevent erosion of the teeth caused by grinding during sleep, such guards may not provide relief from TMJ pain and other jaw-related problems associated with teeth grinding. The mouth guards and treatment methods disclosed herein are provided to address these jaw related problems in a safe and convenient manner.

### SUMMARY OF THE INVENTION

Mouth guard devices embodying the present invention treat causes of teeth grinding permanently. The mouth guards disclosed herein are also configured to be lighter and smaller than conventional mouth guards worn by patients at night. Therefore, the mouth guards disclosed herein relieve pressure on TMJ and the masticatory muscles, and enhance the quality of the user's life.

According to an aspect of the disclosure, a kit for treatment of bite problems includes an upper mouth guard for upper teeth of a patient and a lower mouth guard for lower teeth of a patient. The upper mouth guard includes a molded body having a first portion configured to cover six or fewer upper teeth of the patient including at least upper central incisors of the patient and a second portion configured to contact mucosal tissue of the patient located behind the incisors. The lower mouth guard includes a molded body having a first portion configured to cover six or fewer lower teeth of the patient including at least lower central incisors of the patient and a second portion configured to contact mucosal tissue of the patient's mouth located behind the incisors.

According to another aspect of the disclosure, a method of treating bite problems includes a step of inserting an upper mouth guard over six or fewer upper teeth of a patient's mouth including at least central incisors of the patient and a step of inserting a lower mouth guard over six or fewer lower teeth of the patient including at least the lower central incisors. The upper mouth guard includes: a molded body having a first portion configured to cover the six or fewer upper teeth of the patient and a second portion configured to contact mucosal tissue of the patient located behind the upper central incisors. The lower mouth guard includes: a molded body having a first portion configured to cover the six or fewer lower teeth of the patient and a second portion configured to contact the mucosal tissue of the patient's mouth located behind the lower central incisors.

According to another aspect of the disclosure, a method of forming mouth guards for upper teeth and lower teeth of a patient includes: obtaining at least one mold of the upper teeth and at least one mold of the lower teeth of the patient; applying a thermoplastic material to portions of the mold of the upper teeth to cover six or fewer upper teeth to form an upper mouth guard; and applying a thermoplastic material to portions of the mold of the lower teeth to cover six or fewer lower teeth to form a lower mouth guard. The upper mouth guard includes: a molded body having a first portion configured to cover the six or fewer upper teeth of the patient including at least upper central incisors of the patient and a second portion configured to contact mucosal tissue of the patient located behind the upper central incisors. The lower mouth guard includes a molded body having a first portion configured to cover the six or fewer lower teeth of the patient including at least lower central incisors of the patient and a second portion configured to contact mucosal tissue of the patient's mouth located behind the lower central incisors.

### BRIEF DESCRIPTION OF THE DRAWINGS

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limit of the invention.

Further features and other examples and advantages will become apparent from the following detailed description made with reference to the drawings in which:

FIG. 1A is a perspective view of an upper mouth guard for the upper teeth of a patient, according to an aspect of the disclosure;

FIG. 1B is another perspective view of the upper mouth guard of FIG. 1A showing a front surface of the mouth guard covering front or buccal surfaces of the upper teeth;

FIG. 1C is a bottom view of the upper mouth guard of FIG. 1A;

FIG. 2A is a perspective view of a lower mouth guard for the lower teeth of a patient, according to an aspect of the disclosure; and

FIG. 2B is a top view of the lower mouth guard of FIG. 2A.

### DETAILED DESCRIPTION OF THE INVENTION

As used herein, the terms “right”, “left”, “top”, “bottom”, and derivatives thereof shall relate to the invention as it is oriented in the drawing figures. However, for purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Also, unless indicated otherwise, the disclosure of these ranges is intended as a continuous range including every value between the minimum and maximum values.

As used herein, the terms “comprising,” “comprise” or “comprised,” and variations thereof, are meant to be open ended. The terms “a” and “an” are intended to refer to one or more.

As used herein, the “treatment” or “treating” of a condition, wound, or defect, such as TMJ pain or teeth grinding, means administration to a patient by any suitable dosage regimen, procedure and/or administration route of a composition, device or structure with the object of achieving a desirable clinical/medical end-point.

As used herein, the term “patient” or “subject” refers to members of the animal kingdom including but not limited to human beings and “mammal” refers to all mammals, including, but not limited to human beings.

With reference to the figures, mouth guards 110, 210 configured to be positioned in a patient's mouth to cover the patient's upper teeth 12 and/or lower teeth 14 are provided. The mouth guards 110, 210 are configured to provide a more comfortable and effective appliance for treating jaw related problems, such as TMJ pain, than can be provided by conventional mouth guards. Particularly, the mouth guards 110, 210 disclosed herein can be configured to relax the patient's temporal muscles and to relieve strain to the teeth and jaw caused by clenching teeth in the patient's molar region. In some examples, the mouth guards 110, 210 are shaped to facilitate speech while the patient wears the mouth guard 110, 210.

The mouth guards 110, 210 of the present disclosure can be configured to balance occlusion forces exerted when the patient clenches the upper and/or lower jaw. In some examples, the mouth guards 110, 210 are configured to actively cover and press against the front or anterior teeth 16, while posterior teeth 18 are uncovered and extend passively. Further, the mouth guards 110, 210 can include portions that actively intrude or press against posterior teeth 18, while allowing the front or anterior teeth 16 to extend passively.

In some examples, the mouth guards 110, 210 disclosed herein are designed to more closely match the patient's teeth than conventional mouth guards. Conventional mouth guards are typically custom molded to the teeth. As such, conventional mouth guards include a full arch tray extending around all of the upper or lower teeth. However, an arcuate shape of the mouth can vary greatly from one adult patient to another. Further, lateral spacing of the canine teeth can vary greatly in adults. When the canine teeth are unusually far apart, the canines may not register in the molds of the mouth formed in conventional dental trays. When this happens, either the tray cannot be used for that particular patient, or a modification of the tray by a clinician is required. Unfortunately, making manual modifications to impressions in the arch tray to account for unique spacing of the canine teeth can be difficult and imprecise.

In some examples, the mouth guards 110, 210 are provided as a kit comprising each of an upper mouth guard 110 and a lower mouth guard 210. The upper mouth guard 110 and/or the lower mouth guard 210 can be configured to fit over and press against the front or anterior teeth 16 of the patient. As used herein, the “front” or “anterior” teeth 16 can refer to the six front teeth, namely the canines 20, lateral incisors 22, and central incisors 24. When covering the front or anterior teeth 16, the mouth guards 110, 210 actively press against the front or anterior teeth 16, while allowing posterior teeth 18, namely the premolars or bicuspids 26 and molars 28, to extend passively. The mouth guards 110, 210 can also include portions located immediately behind the front teeth 16 of the patient, which work to actively intrude the posterior teeth 18. In some examples, the mouth guards 110, 210 can actively protrude the posterior teeth 18, while allowing the anterior teeth 16 to extrude passively.

In some examples, a lower mouth guard 210 covering the lower teeth 14 is configured to maintain the patient's mouth in an open position to prevent the patient from clenching the teeth and to relieve pressure on the jaw. For example, the lower mouth guard 210 can be configured to maintain spacing between the upper teeth 12 and the lower teeth 14 so that the mouth remains open. In contrast, an upper mouth guard 110 covering the upper teeth 12 can be provided primarily to protect the upper teeth 12.

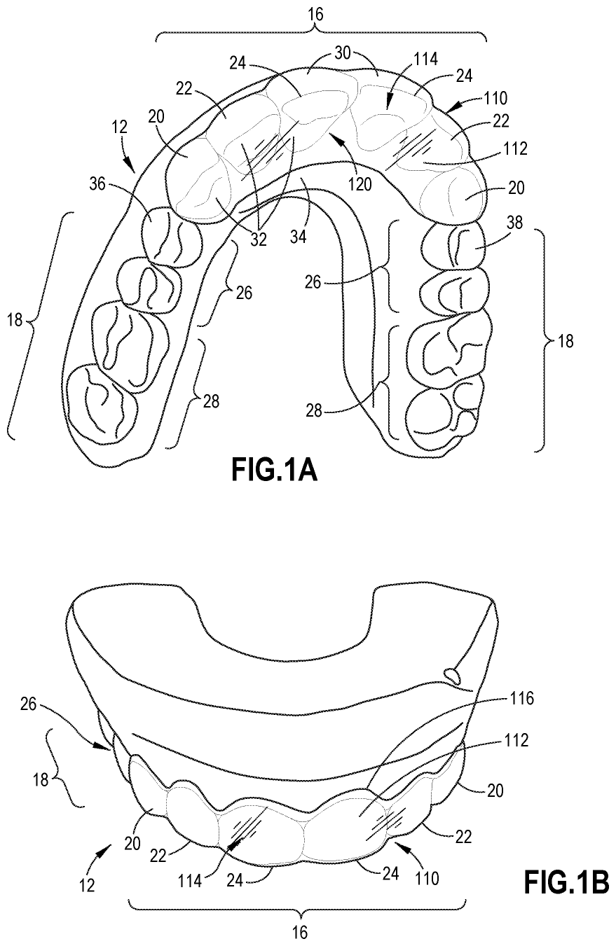

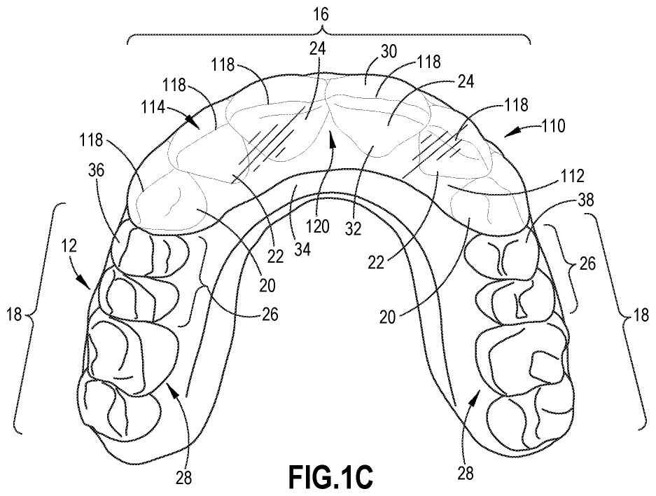

With specific reference to FIGS. 1A-1C, the upper mouth guard 110 is shown mounted to a model of a patient's mouth. The upper mouth guard 110 comprises a molded body 112. The molded body 112 can be formed from a thermoplastic material. For example, the body 112 can be a relatively flexible multilayer structure comprising a medical grade aromatic thermoplastic polyurethane/co-polyester composition. The molded body 112 of the upper mouth guard 110 can be about 0.2 mm to about 0.4 mm thick.

The molded body 112 can comprise a first portion 114 configured to at least partially cover the anterior teeth 16 of the patient. For example, the body 112 can be configured to cover six or fewer upper teeth 12 of the patient, including at least the upper central incisors 24. In some examples, the body 112 of the upper mouth guard 110 covers the canines 20, lateral incisors 22, and central incisors 24 of the patient. The body 112 of the mouth guard 110 can cover the entire front or buccal surface 30 of the teeth 16 and the entire rear or lingual surface 32 of the teeth 16. For example, a lower edge 116 of the first portion 114 can be positioned adjacent to the gum line, as shown in FIG. 1B, such that the mouth guard 110 does not contact portions of the gums below the front or buccal surface 30 of the front teeth 16. In some examples, the body 112 of the mouth guard 110 can define cavities or depressions 118 (shown in FIG. 1C) for receiving individual teeth 16. For example, the body 112 of the upper mouth guard 110 can comprise six depressions 118 sized and configured to receive the six front or anterior teeth 16.

The body 112 of the upper mouth guard 110 further comprises a second portion 120 configured to contact mucosal tissue of the patient's mouth located behind the lateral and/or central incisors 22, 24. As used herein, tissue “located behind” the teeth refers to mucosal tissue, often referred to as lingual tissues 34, located inside the mouth. The second portion 120 of the body 112 can extend from the first portion 114 by any convenient distance determined, for example, based on a size and shape of the patient's mouth and the type of biting problem being treated. For example, the second portion 120 of the mouth guard 110 may extend from a base of the teeth 16 by a distance of about 0.1 mm to about 0.3 mm or, preferably about 0.2 mm.

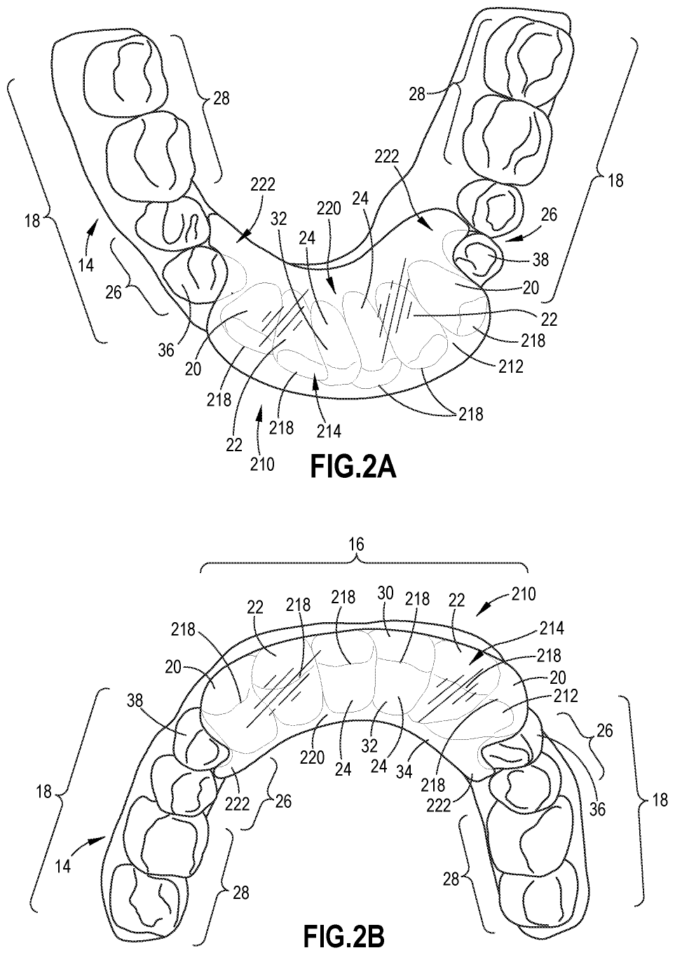

With reference to FIGS. 2A and 2B, the kit for treating bite problems further comprises the lower mouth guard 210. The lower mouth guard 210 can be formed from the same thermoplastic material as the upper mouth guard 110 or from a different material. In some examples, a molded body 212 of the lower mouth guard 210 is formed from acrylic resin. The molded body 212 of the lower mouth guard 210 can be about 1.5 mm to about 2.0 mm thick. The body 212 of the lower mouth guard 210 can be harder and thicker than the upper mouth guard 110, since the lower mouth guard 210 is positioned to open the mouth. In contrast, as discussed previously, the more flexible and thinner upper mouth guard 110 is provided primarily to protect the upper teeth 12.

In some examples, the molded body 212 of the lower mouth guard 210 comprises a first portion 214. As with the upper mouth guard 110, the body 212 of the lower mouth guard 210 is configured to cover six or fewer lower teeth 14 of the patient including at least the lower central incisors 24. In some examples, the body 212 is configured to cover the canines 20, lateral incisors 22, and central incisors 24. The first portion 214 can include individual depressions 218 for receiving the individual teeth. The body 212 can further comprise a second portion 220 configured to contact mucosal tissue of the patient's mouth located behind the lateral and/or central incisors 22, 24. The second portion 220 can extend from an inner or lingual surface 32 of the teeth by a distance of about 0.3 mm to about 0.7 mm or, preferably, about 0.5 mm.

In some examples, the body 212 of the lower mouth guard 210 further comprises a third portion 222 extending from the second portion 220. The third portion 222 is configured to contact tissue behind the patient's posterior teeth 18. For example, the third portion 222 can be configured to contact mucosal tissue of the patient's mouth behind the first bicuspid 36, 38 of the lower teeth 14. In some examples, portions 222 extend from each side of the mouth guard 210. For example, as shown in FIGS. 2A and 2B, the body 212 can comprise a third portion 222 configured to contact mucosal tissue behind the patient's right first bicuspid 36 and another third portion 222 configured to contact tissue behind the patient's left bicuspid 38.

The mouth guards 110, 210 disclosed herein are used for treating conditions caused by biting problems, such as teeth grinding and TMJ pain. As with conventional mouth guards, the mouth guards 110, 210 disclosed herein can be used during sleeping. In some examples, the mouth guards 110, 210 can also be used during waking hours since the mouth guards 110, 210 are shaped to facilitate speech. In order to use the mouth guards 110, 210, the patient inserts the upper mouth guard 110 over the upper front teeth 12 and applies light pressure to the mouth guard 110 to press the mouth guard 110 into place. Similarly, the patient inserts the lower mouth guard 210 into the mouth so that it covers the lower teeth 14. The patient applies light downward pressure on the mouth guard 210 to press the lower mouth guard 210 into place.

The mouth guards 110, 210 disclosed herein are customized appliances, which are molded for use for a particular patient. The mouth guards 110, 210 can be formed by any convenient manufacturing technique, as known in the art. In one example, in order to form the mouth guards 110, 210, a mold of the patient's upper teeth 12 and a mold of the patient's lower teeth 14 are obtained. The molds can be created using conventional molding processes. For example, a tray containing a soft curable gel or similar soft material can be inserted into the patient's mouth and pressed against the upper and/or lower teeth to form an impression of the teeth. The tray can be removed from the mouth and allowed to harden. Once the mold is created or obtained, in order to form the upper guard 110, a clinician can apply a thermoplastic material, such as a thermoplastic gel, to portions of the mold of the upper teeth 12 to form the upper mouth guard 110. Similarly, the clinician can apply thermoplastic material to the mold of the lower teeth 14 to form the lower mouth guard 210. As discussed previously, the mouth guards 110, 112 cover only the front or anterior teeth 16. Therefore, the thermoplastic material is applied only to portions of the mold representing the front or anterior teeth 16. The thermoplastic material is not applied to portions of the mold representing the posterior teeth 18. After the thermoplastic material is applied to the mold, the thermoplastic material is allowed to harden to form the finished mouth guards 110, 210. As discussed previously, the thermoplastic material can be any convenient material having sufficient strength and rigidity to counteract biting and occlusive forces exerted by the patient. The thermoplastic material can be acrylic resin.

The embodiments have been described with reference to various examples. Modifications and alterations will occur to others upon reading and understanding the foregoing examples. Accordingly, the foregoing examples are not to be construed as limiting the disclosure.

Preferred and non-limiting aspects or embodiments of the present invention will now be described in the following numbered clauses:

Clause 1: A kit for treatment of bite problems, the kit comprising: an upper mouth guard for upper teeth of a patient, the upper mouth guard comprising a molded body comprising a first portion configured to cover six or fewer upper teeth of the patient including at least upper central incisors of the patient and a second portion configured to contact mucosal tissue of the patient located behind the incisors; and a lower mouth guard for lower teeth of the patient, the lower mouth guard comprising a molded body comprising a first portion configured to cover six or fewer lower teeth of the patient including at least lower central incisors of the patient and a second portion configured to contact mucosal tissue of the patient's mouth located behind the incisors.

Clause 2: The kit of clause 1, wherein the first portion of the upper mouth guard comprises six or fewer depressions sized to receive the upper teeth of the patient including at least the upper central incisors of the patient.

Clause 3: The kit of clause 1 or clause 2, wherein the first portion of the lower mouth guard comprises six or fewer depressions sized to receive the lower teeth of the patient including at least the lower central incisors of the patient.

Clause 4: The kit of any of clauses 1 to 3, wherein the body of the upper mouth guard and/or the body of the lower mouth guard is configured to cover at least a portion of a buccal surface of each tooth.

Clause 5: The kit of clause 4, wherein the body of the upper mouth guard and/or the body of the lower mouth guard does not contact gums adjacent to the buccal surface of each tooth.

Clause 6: The kit of any of clauses 1 to 5, wherein the lower mouth guard further comprises at least one third portion extending from the second portion of the body, the at least one third portion being configured to contact mucosal tissue of the patient's mouth behind a first bicuspid of the lower teeth.

Clause 7: The kit of any of clauses 1 to 5, wherein the lower mouth guard comprises a third portion configured to contact tissue behind the patient's right first bicuspid and another third portion configured to contact tissue behind the patient's left bicuspid.

Clause 8: The kit of any of clauses 1 to 7, wherein the first portion of the upper mouth guard and/or the first portion of the lower mouth guard is configured to cover the central incisors, lateral incisors, and canines of the patient.

Clause 9: The kit of any of clauses 1 to 8, wherein the body of the upper mouth guard comprises a first material and the body of the lower mouth guard comprises a second material that is harder than the first material.

Clause 10: The kit of clause 9, wherein the first material comprises polyurethane and/or polyester and the second material comprises an acrylic resin.

Clause 11: The kit of clause 1, wherein the body of the upper mouth guard is from 0.2 mm to 0.4 mm thick and the body of the lower mouth guard is from 1.5 mm to 2.0 mm thick.

Clause 12: The kit of any of clauses 1 to 11, wherein, when positioned in the patient's mouth, the lower mouth guard is positioned to at least partially open the jaw and/or mouth.

Clause 13: A method of treating bite problems comprising: inserting an upper mouth guard over six or fewer upper teeth of a patient's mouth including at least central incisors of the patient, wherein the upper mouth guard comprises: a molded body comprising a first portion configured to cover the six or fewer upper teeth of the patient and a second portion configured to contact mucosal tissue of the patient located behind the upper central incisors; and inserting a lower mouth guard over six or fewer lower teeth of the patient including at least the lower central incisors, wherein the lower mouth guard comprises: a molded body comprising a first portion configured to cover the six or fewer lower teeth of the patient and a second portion configured to contact the mucosal tissue of the patient's mouth located behind the lower central incisors.

Clause 14: The method of clause 13, wherein the first portion of the upper mouth guard comprises six or fewer depressions sized to receive the upper teeth of the patient including at least the upper central incisors of the patient, and/or wherein the first portion of the lower mouth guard comprises six or fewer depressions sized to receive the lower teeth of the patient including at least the lower central incisors of the patient.

Clause 15: The method of clause 13 or clause 14, wherein the lower mouth guard further comprises at least one third portion extending from the second portion of the body, the at least one third portion being configured to contact the mucosal tissue of the patient's mouth behind a first bicuspid of the lower teeth.

Clause 16: The method of any of clauses 13 to 15, wherein the first portion of the upper mouth guard and/or the first portion of the lower mouth guard is configured to cover the central incisors, lateral incisors, and canines of the patient.

Clause 17: A method of forming mouth guards for upper teeth and lower teeth of a patient, the method comprising: obtaining at least one mold of the upper teeth and at least one mold of the lower teeth of the patient; applying a thermoplastic material to portions of the mold of the upper teeth to cover six or fewer upper teeth to form an upper mouth guard, wherein the upper mouth guard comprises: a molded body comprising a first portion configured to cover the six or fewer upper teeth of the patient including at least upper central incisors of the patient and a second portion configured to contact mucosal tissue of the patient located behind the upper central incisors; and applying a thermoplastic material to portions of the mold of the lower teeth to cover six or fewer lower teeth to form a lower mouth guard, wherein the lower mouth guard comprises a molded body comprising a first portion configured to cover the six or fewer lower teeth of the patient including at least lower central incisors of the patient and a second portion configured to contact mucosal tissue of the patient's mouth located behind the lower central incisors.

Clause 18: The method of clause 17, wherein the first portion of the upper mouth guard comprises six or fewer depressions sized to receive the upper teeth of the patient including at least the central incisors of the patient, and/or wherein the first portion of the lower mouth guard comprises six or fewer depressions sized to receive the lower teeth of the patient including at least the lower central incisors of the patient.

Clause 19: The method of clause 17 or clause 18, wherein the first portion of the upper mouth guard and/or the first portion of the lower mouth guard is configured to cover the central incisors, lateral incisors, and canines of the patient.

Clause 20: The method of any of clauses 17 to 19, wherein the thermoplastic material applied to form the upper mouth guard and/or the lower mouth guard comprises an acrylic resin.

The invention claimed is:

1. A kit for treatment of bite problems, the kit comprising:
an upper mouth guard for upper teeth of a patient, the upper mouth guard comprising a molded body comprising a first portion configured to cover six or fewer upper teeth of the patient including at least upper central incisors of the patient and a second portion configured to contact mucosal tissue of the patient located behind the incisors; and
a lower mouth guard for lower teeth of the patient, the lower mouth guard comprising a molded body comprising a first portion configured to cover six or fewer lower teeth of the patient including at least lower central incisors of the patient and a second portion configured to contact mucosal tissue of the patient's mouth located behind the incisors.

2. The kit of claim 1, wherein the first portion of the upper mouth guard comprises six or fewer depressions sized to receive the upper teeth of the patient including at least the upper central incisors of the patient.

3. The kit of claim 1, wherein the first portion of the lower mouth guard comprises six or fewer depressions sized to receive the lower teeth of the patient including at least the lower central incisors of the patient.

4. The kit of claim 1, wherein the body of the upper mouth guard and/or the body of the lower mouth guard is configured to cover at least a portion of a buccal surface of each tooth.

5. The kit of claim 4, wherein the body of the upper mouth guard and/or the body of the lower mouth guard does not contact gums adjacent to the buccal surface of each tooth.

6. The kit of claim 1, wherein the lower mouth guard further comprises at least one third portion extending from the second portion of the body, the at least one third portion being configured to contact mucosal tissue of the patient's mouth behind a first bicuspid of the lower teeth.

7. The kit of claim 1, wherein the lower mouth guard comprises a third portion configured to contact tissue behind the patient's right first bicuspid and another third portion configured to contact tissue behind the patient's left bicuspid.

8. The kit of claim 1, wherein the first portion of the upper mouth guard and/or the first portion of the lower mouth guard is configured to cover the central incisors, lateral incisors, and canines of the patient.

9. The kit of claim 1, wherein the body of the upper mouth guard comprises a first material and the body of the lower mouth guard comprises a second material that is harder than the first material.

10. The kit of claim 9, wherein the first material comprises polyurethane and/or polyester, and the second material comprises an acrylic resin.

11. The kit of claim 1, wherein the body of the upper mouth guard is from 0.2 mm to 0.4 mm thick and the body of the lower mouth guard is from 1.5 mm to 2.0 mm thick.

12. The kit of claim 1, wherein, when positioned in the patient's mouth, the lower mouth guard is positioned to at least partially open the jaw and/or mouth.

13. A method of treating bite problems comprising:
inserting an upper mouth guard over six or fewer upper teeth of a patient's mouth including at least central incisors of the patient, wherein the upper mouth guard comprises: a molded body comprising a first portion configured to cover the six or fewer upper teeth of the patient and a second portion configured to contact mucosal tissue of the patient located behind the upper central incisors; and
inserting a lower mouth guard over six or fewer lower teeth of the patient including at least the lower central incisors, wherein the lower mouth guard comprises: a molded body comprising a first portion configured to cover the six or fewer lower teeth of the patient and a second portion configured to contact the mucosal tissue of the patient's mouth located behind the lower central incisors.

14. The method of claim 13, wherein the first portion of the upper mouth guard comprises six or fewer depressions sized to receive the upper teeth of the patient including at least the upper central incisors of the patient, and/or wherein the first portion of the lower mouth guard comprises six or fewer depressions sized to receive the lower teeth of the patient including at least the lower central incisors of the patient.

15. The method of claim 13, wherein the lower mouth guard further comprises at least one third portion extending from the second portion of the body, the at least one third portion being configured to contact the mucosal tissue of the patient's mouth behind a first bicuspid of the lower teeth.

16. The method of claim 13, wherein the first portion of the upper mouth guard and/or the first portion of the lower mouth guard is configured to cover the central incisors, lateral incisors, and canines of the patient.

17. A method of forming mouth guards for upper teeth and lower teeth of a patient, the method comprising:
obtaining at least one mold of the upper teeth and at least one mold of the lower teeth of the patient;
applying a thermoplastic material to portions of the mold of the upper teeth to cover six or fewer upper teeth to form an upper mouth guard, wherein the upper mouth guard comprises:
a molded body comprising a first portion configured to cover the six or fewer upper teeth of the patient including at least upper central incisors of the patient and a second portion configured to contact mucosal tissue of the patient located behind the upper central incisors; and
applying a thermoplastic material to portions of the mold of the lower teeth to cover six or fewer lower teeth to form a lower mouth guard, wherein the lower mouth guard comprises a molded body comprising a first portion configured to cover the six or fewer lower teeth of the patient including at least lower central incisors of the patient and a second portion configured to contact mucosal tissue of the patient's mouth located behind the lower central incisors.

18. The method of claim 17, wherein the first portion of the upper mouth guard comprises six or fewer depressions sized to receive the upper teeth of the patient including at least the central incisors of the patient, and/or wherein the first portion of the lower mouth guard comprises six or fewer depressions sized to receive the lower teeth of the patient including at least the lower central incisors of the patient.

19. The method of claim 17, wherein the first portion of the upper mouth guard and/or the first portion of the lower mouth guard is configured to cover the central incisors, lateral incisors, and canines of the patient.

20. The method of claim 17, wherein the thermoplastic material applied to form the upper mouth guard and/or the lower mouth guard comprises an acrylic resin.
